(19) United States
(12) Patent Application Publication
(10) Pub. No.: US 2015/0241750 A1
(43) Pub. Date: Aug. 27, 2015

(54) LIQUID CRYSTAL DISPLAY

(71) Applicant: Samsung Display Co., Ltd., Yongin-City (KR)

(72) Inventors: Su Jeong KIM, Seoul (KR); Hoon KIM, Ansan-si (KR); Ki Chul SHIN, Seongnam-si (KR); Ji Phyo HONG, Pyeongtaek-si (KR)

(21) Appl. No.: 14/481,200

(22) Filed: Sep. 9, 2014

(30) Foreign Application Priority Data
Feb. 21, 2014 (KR) 10-2014-0020695

(51) Int. Cl. G02F 1/1362

(52) U.S. Cl. CPC G02F 1/136286

(57) ABSTRACT

A liquid crystal includes: a gate line which extends substantially in a first direction, a step-down gate line which extends substantially in the first direction; a data line which extends substantially in a second direction and crosses the gate line; a first thin film transistor connected to the gate line and the data line; a second thin film transistor connected to the gate line and the data line; a third thin film transistor connected to the gate line and the second thin film transistor; a reference voltage line connected to the third thin film transistor; a fourth thin film transistor connected to the step-down gate line, the second thin film transistor and the third thin film transistor; and a pixel electrode including first, second and third subpixel electrodes connected to the first, second and third thin film transistors, respectively.

This application claims priority to Korean Patent Application No. 10-2014-0020695, filed on Feb. 21, 2014, and all the benefits accruing therefrom under 35 U.S.C. §119, the content of which in its entirety is herein incorporated by reference.

### BACKGROUND

(a) Field

Exemplary embodiments of the invention relate to a liquid crystal display.

(b) Description of the Related Art

A liquid crystal display (“LCD”), which is one of the most widely used types of flat panel display, typically includes two panels provided with field-generating electrodes, such as pixel electrodes and a common electrode, and a liquid crystal (“LC”) layer interposed between the two panels. The LCD displays images by applying voltages to the field-generating electrodes to generate an electric field in the LC layer that determines the orientations of LC molecules therein to adjust polarization of incident light.

Recently, a vertical alignment (“VA”) mode LCD, in which longitudinal axes of LC molecules are aligned substantially perpendicular to the panels in the absence of an electric field, is spotlighted because of its high contrast ratio and wide reference viewing angle. Here, the reference viewing angle implies a viewing angle that is 1:10 in contrast ratio, or a critical angle of gray-to-gray luminance reversion.

In the case of the VA mode LCD, in order for side visibility to be close to front visibility, a method is proposed in which one pixel is divided into two subpixels and a voltage of either subpixel thereof is increased or decreased, and as a result, voltages of the two subpixels are different from each other such that transmittances thereof are different from each other.

### SUMMARY

As described above, in a vertical alignment mode liquid crystal display where one pixel is divided into two subpixels and the voltage of either subpixel is increased or decreased to set the voltages of the two subpixels to be different from each other, a loss of luminance may occur in a high gray or color distortion may occur in a middle gray by a bump phenomenon.

Exemplary embodiments of the invention provide a liquid crystal display including a pixel divided into three subpixel regions.

An exemplary embodiment of a liquid crystal display according to the invention includes: a gate line which extends substantially in a first direction, a step-down gate line which extends substantially in the first direction; a data line which extends substantially in a second direction and crosses the gate line; a first thin film transistor connected to the gate line and the data line; a second thin film transistor connected to the gate line and the data line; a third thin film transistor connected to the gate line and the second thin film transistor; a reference voltage line connected to the third thin film transistor; a fourth thin film transistor connected to the step-down gate line, the second thin film transistor and the third thin film transistor; and a pixel electrode including a first subpixel electrode connected to the first thin film transistor, a second subpixel electrode connected to the second thin film transistor, and a third subpixel electrode connected to the third thin film transistor.

In an exemplary embodiment, a voltage applied to the second subpixel electrode may be lower than a voltage applied to the first subpixel electrode.

In an exemplary embodiment, the liquid crystal display may further include a common electrode disposed opposite to the pixel electrode, where a magnitude of a reference voltage applied through the reference voltage line may be greater than a magnitude of a common voltage applied to the common electrode.

In an exemplary embodiment, the liquid crystal display may further a storage electrode line which overlaps a first terminal of the fourth thin film transistor, wherein the storage electrode line defines a step-down capacitor along with the first terminal of the fourth thin film transistor.

In an exemplary embodiment, a second terminal of the fourth thin film transistor may be connected to the third subpixel electrode, and a third terminal of the fourth thin film transistor may be connected to the step-down capacitor.

In an exemplary embodiment, when a gate-on voltage is applied to the fourth thin film transistor through the step-down gate line after the second subpixel electrode and the third subpixel electrode are applied with a same voltage based on a data signal applied through the data line in a previous frame, the voltage charged to the third subpixel electrode may be discharged such that the step-down capacitor may be charged.

In an exemplary embodiment, a first subpixel voltage charged to the first subpixel electrode, a second subpixel voltage charged to the second subpixel electrode and a third subpixel voltage charged to the third subpixel electrode, based on a data signal applied through the data line, may be different from each other.

In an exemplary embodiment, the first subpixel voltage may be larger than the second subpixel voltage, and the second subpixel voltage may be larger than the third subpixel voltage.

In an exemplary embodiment, each of the first subpixel electrode, the second subpixel electrode and the third subpixel electrode may include a cross-shaped stem including a transverse stem and a longitudinal stem crossing the transverse stem, and a plurality of branches extending from the cross-shaped stem.

In an exemplary embodiment, each of the first subpixel electrode, the second subpixel electrode and the third subpixel electrode may include a plurality of regions, in which the branches extend from the cross-shaped stem in different directions from each other.

In an exemplary embodiment, the liquid crystal display may further include a liquid crystal layer including liquid crystal molecules, where the liquid crystal molecules corresponding to the branches may be inclined in a direction corresponding to an extending direction of the branches when a voltage is applied to the pixel electrode.

In an exemplary embodiment, areas of the first subpixel electrode, the second subpixel electrode and the third subpixel electrode may be different from each other.

In an exemplary embodiment, a ratio of the areas of the first subpixel electrode, the second subpixel electrode, and the third subpixel electrode may be about 1:2:6 or about 1:2:4.

According to exemplary embodiments of the invention, the pixel area is divided into three subpixel areas, and the voltages of three subpixel areas are set to be different from each other based on a same data voltage, thereby improving a side gamma curve characteristic.

### BRIEF DESCRIPTION OF THE DRAWINGS

The above and other features of the invention will become more apparent by describing in further detail exemplary embodiments thereof with reference to the accompanying drawings, in which:

FIG. 1 is a diagram schematically illustrating a configuration of a pixel of an exemplary embodiment of a liquid crystal display according to the invention.

FIG. 2 is an equivalent circuit diagram of a pixel of an exemplary embodiment of a liquid crystal display according to the invention.

FIG. 3 is an equivalent circuit diagram showing a first region and a second region in a pixel of an exemplary embodiment of a liquid crystal display according to the invention.

FIG. 4 is a waveform diagram of a signal applied to a pixel of an exemplary embodiment of a liquid crystal display according to the invention.

FIG. 5 is a top plan view of a unit electrode of an exemplary embodiment of a liquid crystal display according to the invention.

### DETAILED DESCRIPTION

The invention now will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereinafter, exemplary embodiments of a liquid crystal display according to the invention will be described in detail with reference to the accompanying drawings.

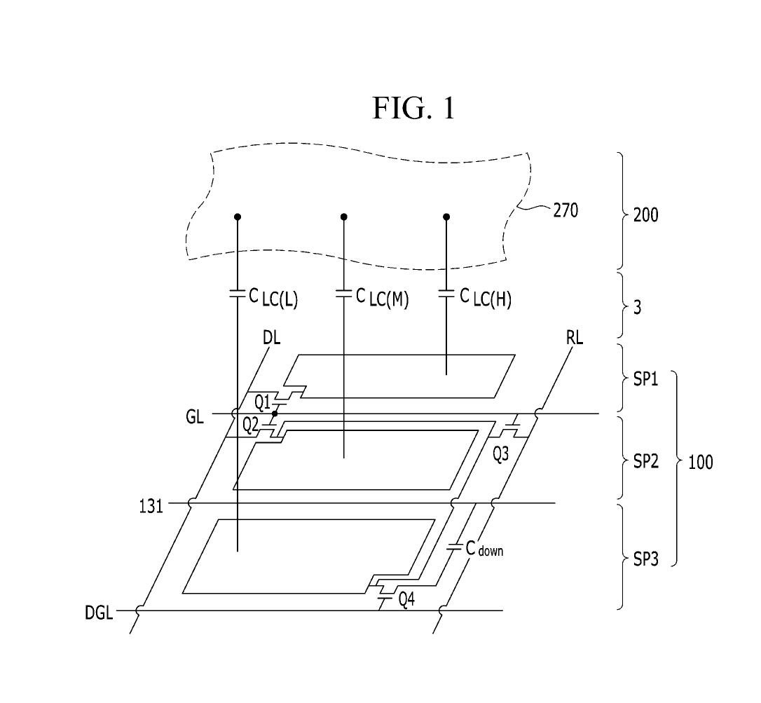

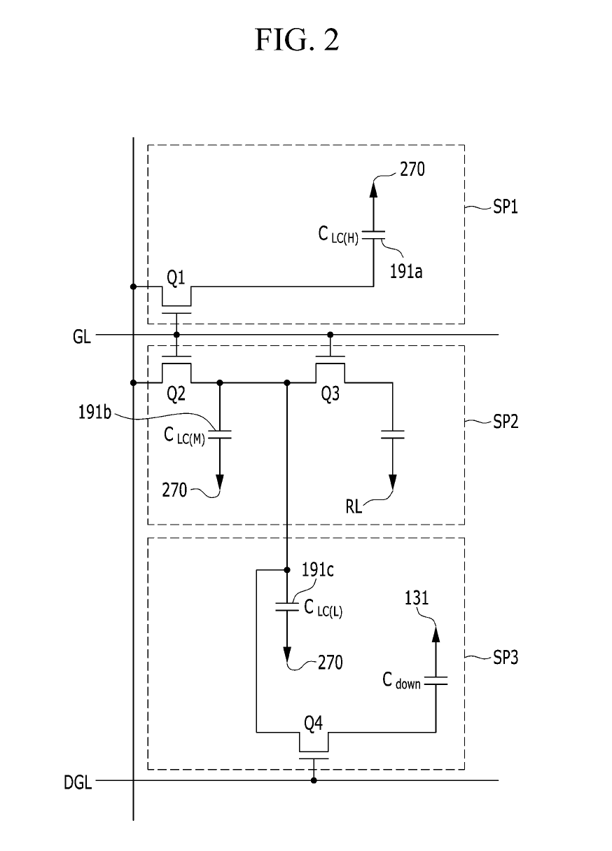

Firstly, an arrangement of a pixel including a signal line and a subpixel of an exemplary embodiment of a liquid crystal display according to the invention will be described with reference to FIG. 1 and FIG. 2.

FIG. 1 is a diagram schematically illustrating a configuration of a pixel of an exemplary embodiment of a liquid crystal display according to the invention. FIG. 2 is an equivalent circuit diagram of a pixel of an exemplary embodiment of a liquid crystal display according to the invention.

Referring to FIG. 1 and FIG. 2, an exemplary embodiment of a liquid crystal display according to the invention includes a lower panel 100 and an upper panel 200 facing to each other and a liquid crystal layer 3 interposed between the lower and upper panels 100 and 200.

In such an embodiment, the liquid crystal display includes a signal line including a plurality of gate lines GL for transmitting a gate signal and a plurality of data lines DL for transmitting a data signal, a reference voltage line RL for transmitting a divided reference voltage, a plurality of step-down gate lines DGL and a plurality of storage electrode lines 131, and a plurality of pixels connected to the signal lines. In FIGS. 1 and 2, only one pixel is shown for convenience of illustration, and the liquid crystal display includes a plurality of pixels arranged substantially in a matrix form, where each pixel may have the configuration shown in FIGS. 1 and 2.

In an exemplary embodiment, a gate line GL and a step-down gate line DGL may extend substantially in a first direction, e.g., a horizontal direction, and a data line DL may extend substantially in a second direction, which is different from the first direction. In one exemplary embodiment, for example, the second direction may be substantially perpendicular to the first direction.

Each pixel includes a plurality of subpixels SP1, SP2 and SP3, and the subpixels SP1, SP2 and SP3 include a plurality of thin film transistors Q1, Q2, Q3 and Q4 and a plurality of liquid crystal capacitors C_{LC(H)}, C_{LC(M)} and C_{LC(L)}.

The thin film transistors Q1, Q2, Q3 and Q4, which may be three terminal elements, include a first thin film transistor Q1, a second thin film transistor Q2, a third thin film transistor Q3 and a fourth thin film transistor Q4.

The first thin film transistor Q1 includes a control terminal connected to a gate line GL, an input terminal connected to a data line DL, and an output terminal connected to a first subpixel electrode 191a, which is one terminal of the first liquid crystal capacitor C_{LC(H)}.

The first liquid crystal capacitor C_{LC(H)} includes the first subpixel electrode 191a and a common electrode 270 as two terminals. A liquid crystal layer 3 between the first subpixel and common electrodes 191a and 270 functions as a dielectric material of the first liquid crystal capacitor C_{LC(H)}.

The second thin film transistor Q2 includes the control terminal connected to the gate line GL, the input terminal connected to the data line DL, and the output terminal connected to a second subpixel electrode 191b as one terminal of the second liquid crystal capacitor C_{LC(M)}.

The second liquid crystal capacitor C_{LC(M)} includes the second subpixel electrode 191b and the common electrode 270 as two terminals. The liquid crystal layer 3 between the second subpixel and common electrodes 191b and 270 functions as a dielectric material of the second liquid crystal capacitor C_{LC(M)}. In an exemplary embodiment, an output terminal of the second thin film transistor Q2 is connected to the third thin film transistor Q3. In such an embodiment, the second thin film transistor Q2 is connected to the fourth thin film transistor Q4.

Hereafter, the third thin film transistor Q3 and the fourth thin film transistor Q4 of an exemplary embodiment of a liquid crystal display according to the invention will be described in greater detail.

In an exemplary embodiment, the third thin film transistor Q3 includes the control terminal connected to the gate line GL, the input terminal connected to the reference voltage line RL, and the output terminal connected to the output terminal of the second thin film transistor Q2.

In such an embodiment, the fourth thin film transistor Q4 includes the control terminal connected to a step-down gate line DGL, the input terminal connected to a step-down capacitor C_{down}, and the output terminal connected to a third subpixel electrode 191c as one terminal of the third liquid crystal capacitor C_{LC(L)}. The step-down capacitor C_{down} is defined by a storage electrode line 131 and a first terminal of the fourth thin film transistor Q4. In an exemplary embodiment, the step-down capacitor C_{down} is defined by portions of the first terminal of the fourth thin film transistor Q4 and the storage electrode line 131 that overlap each other via the insulator.

The third liquid crystal capacitor C_{LC(L)} includes the third subpixel electrode 191c and the common electrode 270 as two terminals thereof, and the liquid crystal layer 3 between the third subpixel and common electrodes 191c and 270 functions as the dielectric material.

In an exemplary embodiment, areas of the first subpixel electrode 191a, the second subpixel electrode 191b and the third subpixel electrode 191c may be different from each other. In one exemplary embodiment, for example, an area ratio of the first subpixel electrode 191a, the second subpixel electrode 191b and the third subpixel electrode 191c may be about 1:2:6 or about 1:2:4. When the area of the first subpixel electrode 191a is relatively small, a wash-out phenomenon of a low gray may be improved, but a brightest area is decreased such that the entire transmittance may be decreased. The area of the second subpixel electrode 191b is provided to reduce a bump phenomenon in which a transmittance curve with respect to grayscale level is sharply decreased downward in a transmittance graph. The area of the third subpixel electrode 191c may be determined based on the transmittance.

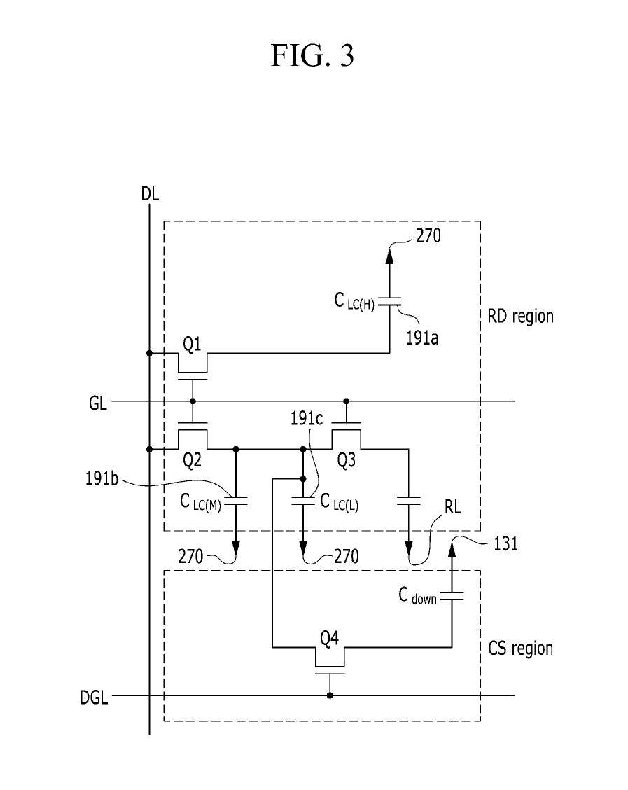

Hereafter, an exemplary embodiment of a driving method of a liquid crystal display, according to the invention, will be described with reference to FIG. 3.

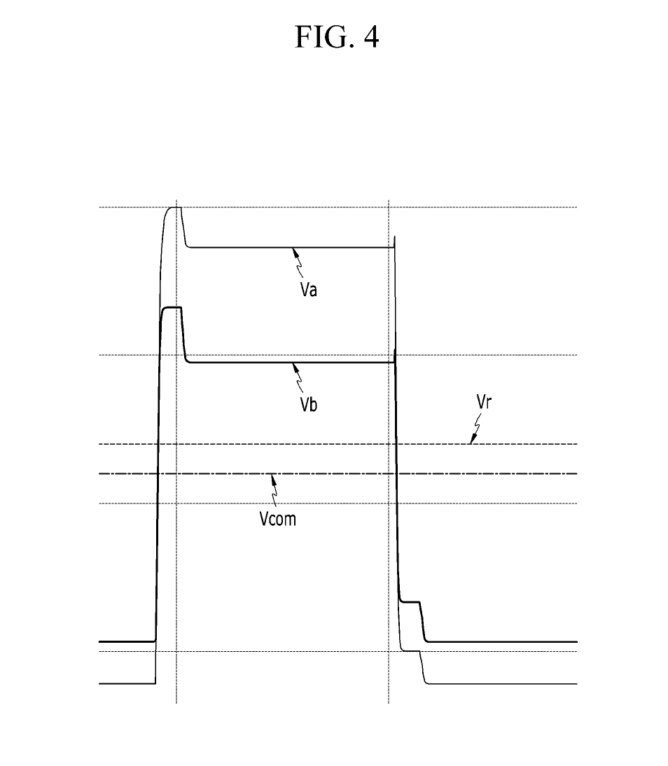

FIG. 3 is an equivalent circuit diagram of a first region (hereinafter, RD region) and a second region (hereinafter, CS region) in a pixel of an exemplary embodiment of a liquid crystal display according to the invention. FIG. 4 is a waveform diagram of a signal applied to a pixel of an exemplary embodiment of a liquid crystal display according to the invention.

First, an operation of the RD region of the pixel will be described with reference to FIG. 3 and FIG. 4.

Referring to FIG. 3 and FIG. 4, when the gate line GL is applied with a gate-on signal, the first thin film transistor Q1, the second thin film transistor Q2 and the third thin film transistor Q3 connected thereto are turned on. Accordingly, a data voltage applied to the data line DL is respectively applied to the first subpixel electrode 191a and the second subpixel electrode 191b through the turned-on first and second thin film transistors Q1 and Q2, and the data voltages applied to the first subpixel electrode 191a and the second subpixel electrode 191b may be the same as each other. However, according to an exemplary embodiment of the invention, the voltage applied to the second subpixel electrode 191b is divided through the third thin film transistor Q3 connected in series to the second thin film transistor Q2. Accordingly, the voltage Vb applied to the second subpixel electrode 191b is smaller than the voltage Va applied to the first subpixel electrode 191a by a difference between the common voltage Vcom and a reference voltage Vr. In such an embodiment, a level of the reference voltage Vr is higher than the level of the common voltage Vcom, and a difference between absolute values of the reference voltage Vr and the common voltage Vcom may be in a range of about 1 volt (V) to about 4 V. In one exemplary embodiment, for example, when the common voltage Vcom is about 7 V, the reference voltage Vr may be in a range of about 8 V to about 11 V.

As a result, in such an embodiment, the voltage charged to the first liquid crystal capacitor C_{LC(H)} and the voltage charged to the second liquid crystal capacitor C_{LC(M)} based on a same data voltage are different from each other. In such an embodiment, the voltage charged to the first liquid crystal capacitor C_{LC(H)} and the voltage charged to the second liquid crystal capacitor C_{LC(M)} are different from each other, such that the inclination angles of the liquid crystal molecules are different in the first subpixel and the second subpixel, and thereby luminance of the two subpixels become different from each other.

Next, an operation of the CS region of the pixel shown in FIG. 3 will be described in greater detail.

Referring to FIG. 3, when the gate line GL is applied with the gate-on voltage such that the first, second and third thin film transistors Q1, Q2 and Q3 are turned on, the step-down gate line DGL is applied with a gate-off voltage.

Next, the gate line GL is applied with the gate-off voltage and simultaneously the step-down gate line DGL is applied with the gate-on voltage, such that the first, second and third thin film transistors Q1, Q2 and Q3 connected to the gate line GL are turned off, and the fourth thin film transistor Q4 is turned on. Accordingly, the charge of the third subpixel electrode 191c connected to one terminal (e.g., the first terminal) of the third thin film transistor Q3 flows into the step-down capacitor C_{down} such that the voltage of the third liquid crystal capacitor C_{LC(L)} is decreased. As a result, the voltage charged to the first liquid crystal capacitor C_{LC(H)}, the voltage charged to the second liquid crystal capacitor C_{LC(M)}, and the voltage charged to the third liquid crystal capacitor C_{LC(L)} are different from each other.

In an exemplary embodiment, the liquid crystal display is driven by frame inversion. In one exemplary embodiment, for example, where a data voltage having a positive (+) polarity based on the common voltage Vcom is applied to the data line DL in a present frame, negative (−) electric charges gather in the step-down capacitor Cdown after a previous frame is finished. When the fourth thin film transistor Q4 is turned on in the present frame, positive (+) electric charges of the second subpixel electrode 191b flow into the step-down capacitor Cdown through the fourth thin film transistor Q4, and thus positive (+) electric charges gather in the step-down capacitor Cdown, and the voltage of the third liquid crystal capacitor C_{LC(L)} is reduced. In a next frame, the fourth thin film transistor Q4 is turned on in a state where negative (−) electric charges are charged in the second subpixel electrode 191b, and thus negative (−) electric charges of the second subpixel electrode 191b flow into the step-down capacitor Cdown, such that negative (−) electric charges gather in the step-down capacitor Cdown and the voltage of the third liquid crystal capacitor C_{LC(L)} is also reduced.

As described above, according to an exemplary embodiment, the charge voltage of the third liquid crystal capacitor C_{LC(L)} may be set to be constantly lower than the charge voltage of the second liquid crystal capacitor C_{LC(M)} regardless of polarity of the data voltage. Accordingly, the charge voltages of the second and third liquid crystal capacitors C_{LC(M)} and C_{LC(L)} may be set to be different from each other.

As a result, by dividing one pixel into three subpixels and appropriately controlling the voltage charged to the first liquid crystal capacitor C_{LC(H)} in the first subpixel, the voltage charged to the second liquid crystal capacitor C_{LC(M)} in the second subpixel, and the voltage charged to the third liquid crystal capacitor C_{LC(L)} in the third subpixel, an image viewed from the side may be closest to an image viewed from the front, thereby improving a side gamma curve characteristic representing side visibility.

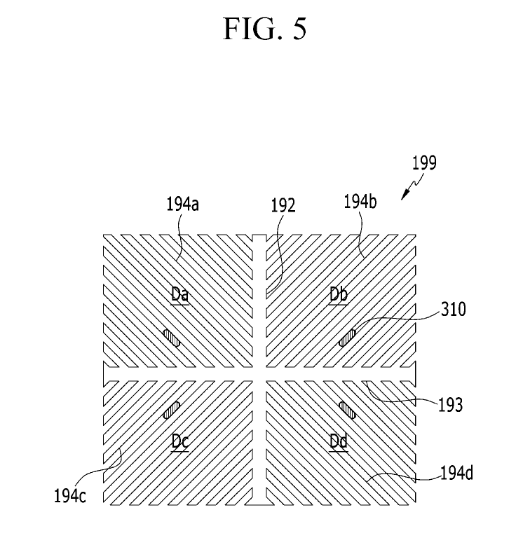

FIG. 5 is a top plan view showing a unit electrode structure of an exemplary embodiment of a liquid crystal display according to the invention.

The unit electrode structure shown in FIG. 5 represents each electrode structure of the first subpixel electrode 191a, the second subpixel electrode 191b, and the third subpixel electrode 191c in an exemplary embodiment of a liquid crystal display according to the invention.

As shown in FIG. 5, an overall shape of a unit electrode 199 is substantially quadrangular, and the unit electrode 199 includes a cross-shaped stem including a transverse stem 193 and a vertical stem 192, which are substantially perpendicular to each other. In an exemplary embodiment, the unit electrode 199 is divided into four subregions, e.g., a first subregion Da, a second subregion Db, a third subregion Dc and a fourth subregion Dd, by the transverse stem 193 and the vertical stem 192, and each subregion Da, Db, Dc or Dd includes a plurality of first to fourth minute branches 194a, 194b, 194c or 194d.

In an exemplary embodiment, as shown in FIG. 5, the first minute branch 194a obliquely extends from the transverse stem 193 or the longitudinal stem 192 in a upper-left direction, and the second minute branch 194b obliquely extends from the transverse stem 193 or the longitudinal stem 192 in a upper-right direction. In such an embodiment, the third minute branch 194c obliquely extends from the transverse stem 193 or the longitudinal stem 192 in a lower-left direction, and the fourth minute branch 194d obliquely extends from the transverse stem 193 or the longitudinal stem 192 in a lower-right direction.

In one exemplary embodiment, for example, the first to fourth minute branches 194a, 194b, 194c and 194d form an angle of about 45 degrees or 135 degrees with the gate line GL or the transverse stem 193. In such an embodiment, the minute branches 194a-194d of two neighboring subregions Da-Dd may be substantially perpendicular to each other.

In an exemplary embodiment, the width of the minute branches 194a, 194b, 194c and 194d may be in a range of about 2.5 micrometers (pm) to about 5.0 μm, and the interval between the neighboring minute branches 194a, 194b, 194c and 194d of one subregion Da, Db, Dc, and Dd may be in a range of about 2.5 μm to about 5.0 μm.

In an exemplary embodiment, although not shown in the drawing, the widths of the minute branches 194a, 194b, 194c and 194d may be enlarged as moving closer to the transverse stem 193 or the longitudinal stem 192.

In the entire pixel electrode including all of the first subpixel electrode 191a, the second subpixel electrode 191b and the third subpixel electrode 191c, the area occupied by the third subpixel electrode 191c is the largest, the area occupied by the second subpixel electrode 191b is middle, and the area occupied by the first subpixel electrode 191a is the smallest.

Referring back to FIG. 2, the first, second and third subpixels SP1, SP2 and SP3 including each subpixel electrode may have four domains. Accordingly, in an exemplary embodiment, one pixel of the liquid crystal display may have a total of twelve domains. In an exemplary embodiment, liquid crystal molecule 310 may incline to an extending direction of the minute branches 194a, 194b, 194c and 194d.

While the invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal display comprising:
a gate line which extends substantially in a first direction;
a step-down gate line which extends substantially in the first direction;
a data line which extends substantially in a second direction and crosses the gate line;
a first thin film transistor connected to the gate line and the data line;
a second thin film transistor connected to the gate line and the data line;
a third thin film transistor connected to the gate line and the second thin film transistor;
a reference voltage line connected to the third thin film transistor;
a fourth thin film transistor connected to the step-down gate line, the second thin film transistor and the third thin film transistor; and
a pixel electrode comprising:
a first subpixel electrode connected to the first thin film transistor;
a second subpixel electrode connected to the second thin film transistor; and
a third subpixel electrode connected to the third thin film transistor.

2. The liquid crystal display of claim 1, wherein
a voltage applied to the second subpixel electrode is lower than a voltage applied to the first subpixel electrode.

3. The liquid crystal display of claim 2, further comprising:
a common electrode disposed opposite to the pixel electrode,
wherein a magnitude of a reference voltage applied through the reference voltage line is greater than a magnitude of a common voltage applied to the common electrode.

4. The liquid crystal display of claim 3, further comprising:
a storage electrode line which overlaps a first terminal of the fourth thin film transistor, wherein the storage electrode line defines a step-down capacitor along with the first terminal of the fourth thin film transistor.

5. The liquid crystal display of claim 4, wherein
a second terminal of the fourth thin film transistor is connected to the third subpixel electrode, and
a third terminal of the fourth thin film transistor is connected to the step-down capacitor.

6. The liquid crystal display of claim 5, wherein
when a gate-on voltage is applied to the fourth thin film transistor through the step-down gate line in a frame after the second subpixel electrode and the third subpixel electrode are applied with a same voltage based on a data signal applied through the data line in a previous frame, a voltage charged to the third subpixel electrode is discharged such that the step-down capacitor is charged.

7. The liquid crystal display of claim 5, wherein
a first subpixel voltage charged to the first subpixel electrode, a second subpixel voltage charged to the second subpixel electrode, and a third subpixel voltage charged to the third subpixel electrode, based on a data signal applied through the data line, are different from each other.

8. The liquid crystal display of claim 7, wherein
the first subpixel voltage is larger than the second subpixel voltage, and
the second subpixel voltage is larger than the third subpixel voltage.

9. The liquid crystal display of claim 1, wherein
each of the first subpixel electrode, the second subpixel electrode and the third subpixel electrode comprises:
a cross-shaped stem comprising a transverse stem, and a longitudinal stem crossing the transverse stem; and
a plurality of branches extending from the cross-shaped stem.

10. The liquid crystal display of claim 9, wherein
each of the first subpixel electrode, the second subpixel electrode and the third subpixel electrode further comprises a plurality of regions, in which the branches extend from the cross-shaped stem in different directions from each other.

11. The liquid crystal display of claim 10, further comprising
a liquid crystal layer comprising liquid crystal molecules, wherein of the liquid crystal molecules corresponding to the branches are inclined in a direction corresponding to an extending direction of the branches when a voltage is applied to the pixel electrode.

12. The liquid crystal display of claim 1, wherein
areas of the first subpixel electrode, the second subpixel electrode and the third subpixel electrode are different from each other.

13. The liquid crystal display of claim 12, wherein
a ratio of the areas of the first subpixel electrode, the second subpixel electrode and the third subpixel electrode is about 1:2:6 or about 1:2:4.

14. The liquid crystal display of claim 1, wherein
a first subpixel voltage charged to the first subpixel electrode, a second subpixel voltage charged to the second subpixel electrode and a third subpixel voltage charged to the third subpixel electrode, based on a data signal applied through the data line, are different from each other.

15. The liquid crystal display of claim 14, wherein
the first subpixel voltage is larger than the second subpixel voltage, and
the second subpixel voltage is larger than the third subpixel voltage.

16. The liquid crystal display of claim 15, wherein
areas of the first subpixel electrode, the second subpixel electrode, and the third subpixel electrode are different from each other.
